(19) United States
(12) Patent Application Publication
(10) Pub. No.: US 2017/0242582 A1
(43) Pub. Date: Aug. 24, 2017

(54) METHOD AND APPARATUS FOR PROCESSING USER INPUT

(71) Applicant: YANDEX EUROPE AG, Luzern (CH)

(72) Inventor: Nikolay Anatolievitch YAREMKO, Ekaterinburg, Sverdlovsk region (RU)

(21) Appl. No.: 15/513,744

(22) PCT Filed: Nov. 18, 2015
(86) PCT No.: PCT/IB15/58930

§ 371 Date: Mar. 23, 2017

(30) Foreign Application Priority Data
Apr. 24, 2015 (RU) 2015115580

(51) Int. Cl. G06F 3/0488; G06F 3/0482; G06F 3/041

(52) U.S. Cl. CPC G06F 3/04886; G06F 3/041; G06F 3/0482; G06F 3/0488

(57) ABSTRACT

There is disclosed a method (1000) of processing a user input command, the method executable on an electronic device (302). The electronic device (302) hasa machine-user interface (304). The method (1000) comprises: presenting on a first portion (322) of the machine-user interface (304) a symbol selection tool (320), the first portion (322) being a portion of a touch-sensitive screen (304); presenting on a second portion (328) of the machine-user interface (304) an entry confirmation tool (326, 426); receiving, from the symbol selection tool (320), a first command representative of the user selecting a particular symbol using the symbol selection tool (320); receiving, from the entry confirmation tool (326, 426), a second command representative of the user interacting with the entry confirmation tool (326, 426); and processing the particular symbol as an entry symbol, only in response to the first command and the second command being indicative that the user interacting with the entry confirmation tool overlaps (326, 426), at least partially, with the user selecting the particular symbol using the symbol selection tool (320).

### CROSS-REFERENCE

The present application claims priority to Russian Patent Application No 2015115580, filed Apr. 24, 2015, entitled “METHOD AND APPARATUS FOR PROCESSING USER INPUT” the entirety of which is incorporated herein.

### TECHNICAL FIELD

The present technology relates to methods and apparatuses for processing user input, and more specifically to a method and an apparatus for processing user input from a touch-sensitive screen.

### BACKGROUND

A typical user has access to a plethora of electronic devices for executing one or more user tasks. Just as an example, a typical user may have one or more of a desktop computer, a laptop computer, a game console, a tablet device and a smartphone device (as well as a number of additional electronic devices). Depending on the user's habits, the user may use some of these devices for specific tasks, for example, the user may predominantly use the tablet device for reading news, while the laptop device for word processing. However, with the convergence in functionality of electronic devices, the user typically uses different devices for executing substantially the same set of tasks, albeit in different circumstances. For example, the user may use the desktop computer while at home, the laptop while at the office and the smartphone or the tablet device while in transit or waiting boarding for a plane at the airport.

Depending on the type of the electronic device, the electronic devices typically have different types of user input-output devices. For example, a typical desktop computer may have a keyboard and a mouse for enabling the user to input data, as well as a monitor for outputting data to the user. A typical laptop may have a key board, a track pad and/or a track ball for enabling the user to input data, as well as a screen to output data to the user.

A typical tablet device (as well as some of the smartphones) has what is known as a touch sensitive screen—a display that performs both an input function and an output function. The input function is typically executed by means of displaying to the user a virtual key board and acquiring a signal indicative of a user touch of a particular region of the virtual key board and by processing an associated symbol or command associated with the particular region of the virtual key board.

A typical virtual key board is illustrated with reference to FIG. 1, which depicts a typical prior art tablet device 102 with the virtual key board displayed thereupon. The illustrated prior art tablet device 102 is an iPad™ tablet device provided by Apple Inc., a corporation of 1 Infinite Loop, Cupertino, Calif. 95014, United States of America. Within the illustration of FIG. 1, the tablet device 102 is shown with a touch sensitive display 104. The touch sensitive display 104 displays a Yandex™ browser application, generally depicted as a screen shot 106.

Within the screenshot 106, there is shown a browser interface 108, a bookmarks interface 110 and a virtual key board 112. It is noted that the screenshot 106 is depicted in an entry configuration—where the user has indicated her desire to enter a search term or a web address into an omnibox 114 of the browser interface 108. Within this configuration of the browser interface 108, the bookmarks interface 110 and the virtual key board 112 are displayed over (or instead of) whatever content was shown within the browser application before the user has indicated her desire to use the omnibox 114.

In other known solutions, the bookmarks interface 110 can be omitted. An example of these alternative prior art implementations is depicted in FIG. 2, which depicts a tablet device 202, with a touch sensitive display 204. The touch sensitive display 204 displays a Google™ browser application, generally depicted as a screen shot 206.

Within the screenshot 206, there is shown a browser interface 208, a content interface 210 and a virtual key board 212. It is noted that the screenshot 206 is depicted in an entry configuration—where the user has indicated her desire to enter a search term or a web address into either an address field 214 or a search interface 216 of the browser interface 208. Within this configuration of the browser interface 208, the virtual key board 212 is displayed over a portion of the content that was shown within the content interface before the user has indicated her desire to use the address field 214 or the search interface 216. Hence, the content shown within the content interface 210 is shown is a partially greyed out mode.

### SUMMARY

It is an object of the present technology to ameliorate at least some of the inconveniences present in the prior art.

Developers have appreciated that there exists at least one technical problem associated with the current state of the art approaches to implementing input-output interfaces of known tablet devices 102, 202—such as the virtual keyboard 112, 212. Generally, those skilled in the art are faced with a dilemma—how to make the keys associated with the virtual keyboard 112, 212 big enough (to enable the user to conveniently hit the keys), while not obstructing too much of a portion of the touch sensitive display 204. For example, within the illustration of FIG. 1, which shows the touch sensitive display 104 in a landscape mode, the virtual keyboard 112 takes about fifty percent of the available real estate of the touch sensitive display 104. Within the illustration of FIG. 2, which shows the touch sensitive display 204 in a portrait mode, the virtual keyboard 212 occupies about one third of the available real estate of the touch sensitive display 204

In those implementations where the real estate of the touch sensitive display 104, 204 (such as smaller-sized tablet devices or smartphones) is even smaller, the proportion of the real estate of the touch sensitive display 104, 204 occupied by respective virtual keyboards 112, 212 can be even larger.

Hence, those skilled in the art can be said to be faced with a technical problem of balancing real estate of the touch sensitive displays 104, 204 that is dedicated for displaying virtual keyboards 112, 212 with displaying other content. Another problem is associated with making the virtual keyboards 112, 212 as user-friendly as possible—either when the size of the touch sensitive displays 104, 204 is relatively smaller, or when the tablet devices 102, 202 are used by users with larger fingers and/or elderly users.

According to a first broad aspect of the present technology, there is provided a method of processing a user input command, the method executable on an electronic device, the electronic device having a machine-user interface, the method comprising: presenting on a first portion of the machine-user interface a symbol selection tool, the first portion being a portion of a touch-sensitive screen; presenting on a second portion of the machine-user interface an entry confirmation tool; receiving, from the symbol selection tool, a first command representative of the user selecting a particular symbol using the symbol selection tool; receiving, from the entry confirmation tool, a second command representative of the user interacting with the entry confirmation tool; and processing the particular symbol as an entry symbol, only in response to the first command and the second command being indicative that the user interacting with the entry confirmation tool overlaps, at least partially, with the user selecting the particular symbol using the symbol selection tool.

In some implementations of the method, the first portion of the machine-user interface comprises a first virtual keyboard.

In some implementations of the method, the second portion comprises a second virtual keyboard.

In some implementations of the method, the first portion of the machine-user interface comprises a first virtual keyboard and the second portion comprises a second virtual keyboard, and wherein the first virtual key board located in a first part of the machine-user interface and the second virtual keyboard is located in a second part of the machine-user interface.

In some implementations of the method, the first part and the second part are located at opposing ends of the machine-user interface to enable the user to operate the first virtual keyboard with one hand and the other virtual keyboard with another hand.

In some implementations of the method, the first part and the second part are separated by an information presentation space.

In some implementations of the method, the method further comprises presenting, within the information presentation space, an additional information component.

In some implementations of the method, the additional information component comprises a representation of the symbol being processed.

In some implementations of the method, the additional information component comprises a suggested entry completion, based at least in part on the symbol being processed.

In some implementations of the method, the method further comprises predicting a plurality of potential suggested entry completions and selecting a subset of the potential suggested entry completions, the subset of the potential suggested entry completions including at least the suggested entry completion.

In some implementations of the method, the method further comprises displaying, within another portion of the machine-user interface an application having content, and wherein the additional information component comprises a command interface for enabling the user to enter at least one command for interacting with at least one of the application and the content.

In some implementations of the method, the method further comprises presenting, within the entry confirmation tool, a special symbol command interface, the special symbol command interface for enabling the user to enter at least one command for augmenting the symbol being entered.

In some implementations of the method, the method further comprises: receiving, from the entry confirmation tool, a third command, the third command being of a different type from the second command; and processing the third command as an indication of an entry of a special symbol, different from the particular symbol potentially selectable using the symbol selection tool.

In some implementations of the method, the second portion of the machine-user interface is implemented as a virtual key board, and receiving the second command is executed in response to a tap of at least a portion of the entry confirmation tool; receiving the third command is executed in response to a swipe over at least a portion of the entry confirmation tool.

In some implementations of the method, the method further comprises detecting a direction of the swipe and wherein the special symbol is selected based on the direction of the swipe.

In some implementations of the method, the receiving, from the symbol selection tool, a first command representative of the user selecting a particular symbol using the symbol selection tool is executed in response to: the user executing a sliding action over the symbol selection tool, the symbol selection tool having a plurality of discrete zones, each of the plurality of discrete zones corresponding to an associated symbol; the first command being generated in response to the user sliding from one of the plurality of discrete zones to another one of the plurality of discrete zones.

In some implementations of the method, after sliding to the another one of the plurality of discrete zones, the user disengages the symbol selection tool and wherein the processing the particular symbol as an entry symbol is executed in response to the first command and the second command being indicative that the user interacting with the entry confirmation tool is executed within the predetermined time period after the user disengaging the symbol selection tool.

In some implementations of the method, the receiving, from the entry confirmation tool, a second command representative of the user interacting with the entry confirmation tool is executed in response to the user actuating the entry confirmation tool.

In some implementations of the method, the second portion comprises a physical keyboard.

In some implementations of the method, the electronic device comprises a tablet device.

In some implementations of the method, the tablet device is optimized for use in a landscape mode of operation.

According to another broad aspect of the present technology, the reis provided a electronic device comprising: a user input output interface; a processor coupled to the user input output interface, the processor configured to: present on a first portion of the machine user interface a symbol selection tool, the first portion being a portion of a touch-sensitive screen; present on a second portion of the machine-user interface an entry confirmation tool;

receive, from the symbol selection tool, a first command representative of the user selecting a particular symbol using the symbol selection tool; receive, from the entry confirmation tool, a second command representative of the user interacting with the entry confirmation tool; and process the particular symbol as an entry symbol, only in response to the first command and the second command being indicative that the user interacting with the entry confirmation tool overlaps, at least partially, with the user selecting the particular symbol using the symbol selection tool.

In some implementations of the electronic device, the first portion of the machine-user interface comprises a first virtual keyboard.

In some implementations of the electronic device, the second portion comprises a second virtual keyboard.

In some implementations of the electronic device, the first portion of the machine-user interface comprises a first virtual keyboard and the second portion comprises a second virtual keyboard, and wherein the first virtual key board located in a first part of the machine-user interface and the second virtual keyboard is located in a second part of the machine-user interface.

In some implementations of the electronic device, the first part and the second part are located at opposing ends of the machine-user interface to enable the user to operate the first virtual keyboard with one hand and the other virtual keyboard with another hand.

In some implementations of the electronic device, the first part and the second part are separated by an information presentation space.

In some implementations of the electronic device, the processor is further configured to present, within the information presentation space, an additional information component.

In some implementations of the electronic device, the additional information component comprises a representation of the symbol being processed.

In some implementations of the electronic device, the additional information component comprises a suggested entry completion, based at least in part on the symbol being processed.

In some implementations of the electronic device, the processor is further configured to display, within another portion of the machine-user interface an application having content, and wherein the additional information component comprises a command interface for enabling the user to enter at least one command for interacting with at least one of the application and the content.

In some implementations of the electronic device, the processor is further configured to present, within the entry confirmation tool, a special symbol command interface, the special symbol command interface for enabling the user to enter at least one command for augmenting the symbol being entered.

In some implementations of the electronic device, the processor is further configured to: receive, from the entry confirmation tool, a third command, the third command being of a different type from the second command; and process the third command as an indication of an entry of a special symbol, different from the particular symbol potentially selectable using the symbol selection tool.

In some implementations of the electronic device, the processor is configured to receive, from the symbol selection tool, a first command representative of the user selecting a particular symbol using the symbol selection tool, in response to: the user executing a sliding action over the symbol selection tool, the symbol selection tool having a plurality of discrete zones, each of the plurality of discrete zones corresponding to an associated symbol; the first command being generated in response to the user sliding from one of the plurality of discrete zones to another one of the plurality of discrete zones.

In some implementations of the electronic device, after sliding to the another one of the plurality of discrete zones, the user disengages the symbol selection tool and wherein the processing the particular symbol as an entry symbol is executed in response to the first command and the second command being indicative that the user interacting with the entry confirmation tool is executed within the predetermined time period after the user disengaging the symbol selection tool.

In some implementations of the electronic device, the electronic device comprises a tablet device.

In some implementations of the electronic device, the tablet device is optimized for use in a landscape mode of operation.

In the context of the present specification, unless expressly provided otherwise, a “server” is a computer program that is running on appropriate hardware and is capable of receiving requests (e.g. from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, unless expressly provided otherwise, “client device” is any computer hardware that is capable of running software appropriate to the relevant task at hand. Thus, some (non-limiting) examples of client devices include personal computers (desktops, laptops, netbooks, etc.), smartphones, and tablets. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, unless expressly provided otherwise, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, unless expressly provided otherwise, the expression “component” is meant to include software (appropriate to a particular hardware context) that is both necessary and sufficient to achieve the specific function(s) being referenced.

In the context of the present specification, unless expressly provided otherwise, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, unless expressly provided otherwise, the expression “interactive” is meant to indicate that something is responsive to a user's input or that at least portions thereof are responsive to a user's input.

In the context of the present specification, unless expressly provided otherwise, an “indication” of an information element may be the information element itself or a pointer, reference, link, or other indirect mechanism enabling the recipient of the indication to locate a network, memory, database, or other computer-readable medium location from which the information element may be retrieved. For example, an indication of a file could include the file itself (i.e. its contents), or it could be a unique file descriptor identifying the file with respect to a particular file system, or some other means of directing the recipient of the indication to a network location, memory address, database table, or other location where the file may be accessed. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a front view of an electronic device implemented in accordance with known techniques, the tablet device depicting an implementation of virtual keyboards according to some known techniques.

FIG. 2 is a front view of an electronic device implemented in accordance with some other known techniques, the tablet device depicting an implementation of virtual keyboards according to some other known techniques.

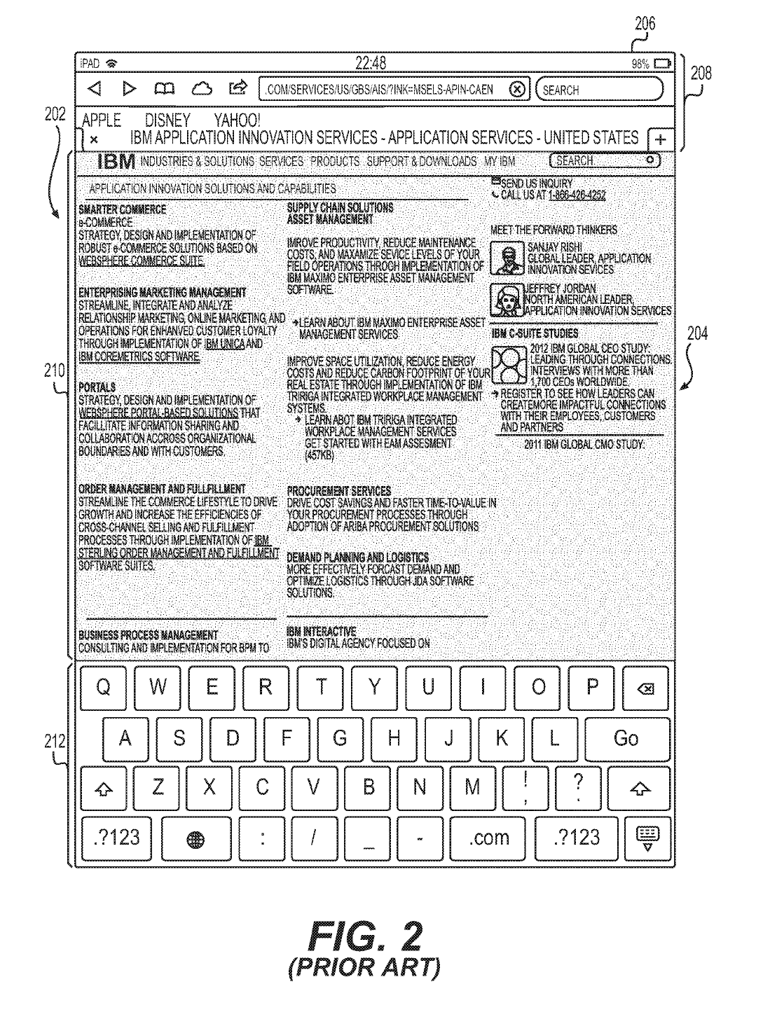

FIG. 3 depicts a front view of an electronic device implemented in accordance with non-limiting embodiments of the present technology, the tablet device depicting an implementation of a virtual keyboard implemented in accordance with non-limiting embodiments of the present technology.

FIG. 4 depicts a front view of the electronic device of FIG. 3, the tablet device depicting an implementation of the virtual keyboard with an optional enhancement.

FIG. 5 depicts a front view of the electronic device of FIG. 3, the tablet device depicting an implementation of the virtual keyboard with another optional enhancement.

FIG. 6 depicts a front view of the electronic device of FIG. 3, the electronic device being implemented in accordance with the non-limiting embodiments of the present technology.

FIG. 7 depicts a back view of the electronic device of FIG. 6.

FIG. 8 depicts a side view of the electronic device of FIG. 6.

FIG. 9 depicts a schematic diagram of the electronic device of FIG. 6.

FIG. 10 depicts a flow chart of a method, the method implemented within the tablet device of FIG. 3, the method being implemented in accordance with the non-limiting embodiments of the present technology.

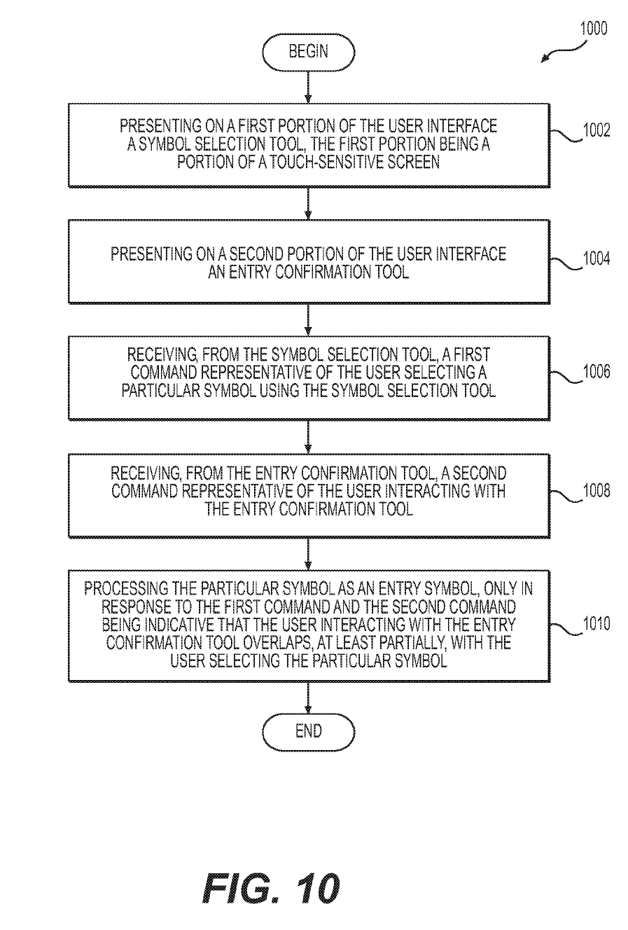

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “graphics processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

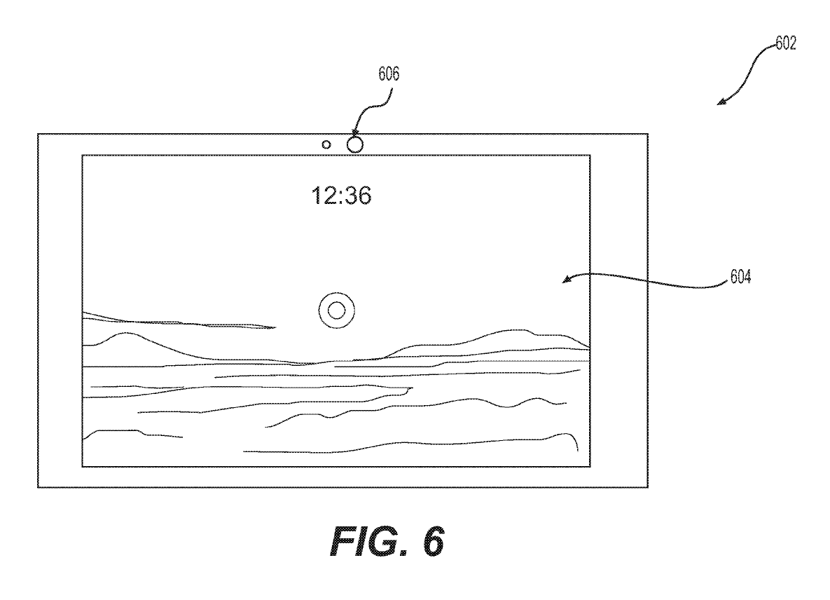

With reference to FIG. 6, there is depicted a front view of the electronic device 602, the electronic device 602 being implemented in accordance with the non-limiting embodiments of the present technology. Within the illustration of FIG. 6, the electronic device 602 is executed as a tablet electronic device and, as such, can be referred to herein below as a tablet device 602.

However, it should be expressly understood that the teachings of embodiments of the present technology are not limited to the electronic devices 602 being implemented as tablets.

As such, teachings presented herein can be adapted by those of ordinary skill in the art to other type of wireless electronic devices (a cell phone, a smartphone, a personal digital assistant and the like), as well as a personal computer (desktops, laptops, netbooks, etc.), or even network equipment (a router, a switch, or a gateway).

In the depicted illustration of FIG. 6, the tablet device 602 can be an ANDROID™ based tablet device in the sense that the tablet device 602 operates on the ANDROID based mobile operating system (OS), which in turn can be based on a Linux kernel and currently being promulgated by Google Corporation of Googleplex, Mountain View, California, United States of America. However, in alternative non-limiting embodiments, the tablet device 602 can operate on a different type of an operating system, such as (but not limited to): WINDOWS™ operating system, iOS, MAC OS and the like.

The general construction of the tablet device 602 is well known to those of skill in the art and, as such, only a high level description thereof will be presented here.

Within the depicted illustration, the tablet device 602 comprises an input output module 604. Input output module 604 may comprise one or more input and output devices. For example, input output module 604 may include keyboard, mouse, one or more buttons, thumb wheel, and/or display (e.g., liquid crystal display (LCD), light emitting diode (LED), Interferometric modulator display (IMOD), or any other suitable display technology).

Generally, the input portion of the input output module 604 is configured to transfer data, commands and responses from the outside world into the tablet device 602. The output portion of the input output module 604 is generally configured to display a graphical user interface (GUI) that provides an easy to use visual interface between a user of the tablet device 602 and the operating system or application(s) running on the tablet device 602. Generally, the GUI presents programs, files and operational options with graphical images. During operation, the user may select and activate various graphical images displayed on the display in order to initiate functions and tasks associated therewith.

In the depicted embodiment, the input output module 604 is implemented as a touch screen, which implements functionality of both an input device (by means of acquiring user's touch based commands) and an output device (i.e. a screen). In other words, the touch screen is a display that detects the presence and location of user touch-based inputs. In alternative embodiments, the input output module 604 can be implemented as a separate output device and a separate input device. In yet alternative embodiments, the input output module 604 can include a physical interface (including one or more physical buttons) in addition to the touch screen.

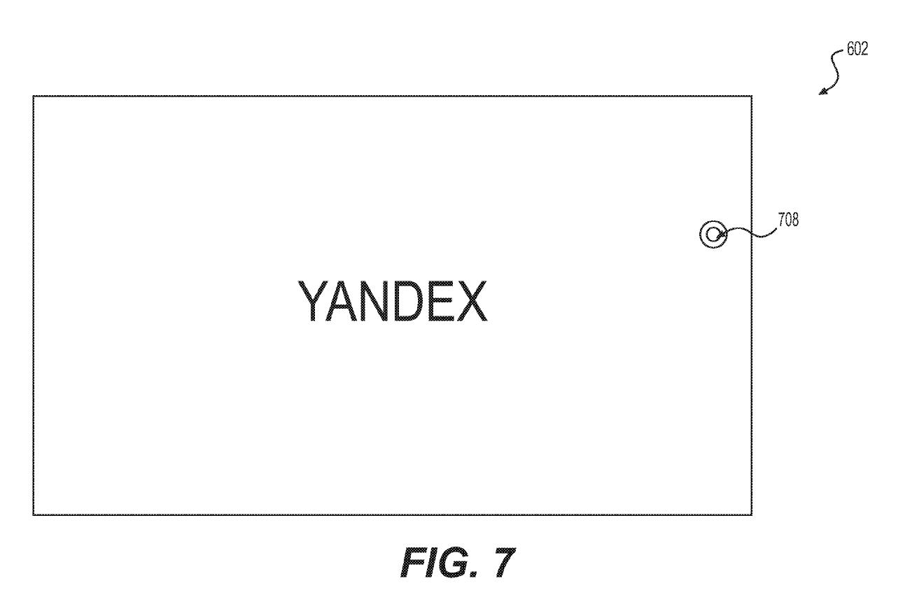

With continued reference to FIG. 6 and with additional reference to FIG. 7, which depicts a back view of the tablet device 602, the tablet device 602 comprises a front camera 606 and a back camera 708, together referred to as cameras 606, 708. For example, the cameras 606, 708 can include an optical sensor (e.g., a charged coupled device (CCD), or a complementary metal-oxide semiconductor (CMOS) image sensor), to facilitate camera functions, such as recording photographs and video clips.

Even though in the depicted embodiment, both the front camera 606 and the back camera 708 are present, in alternative embodiments only a single instance thereof can be implemented. By the same token, one or both of the front camera 606 and the back camera 708 can include multiples thereof. Finally, the exact placement of the front camera 606 and the back camera 708 is not limited to those placements depicted in FIG. 6 and FIG. 7.

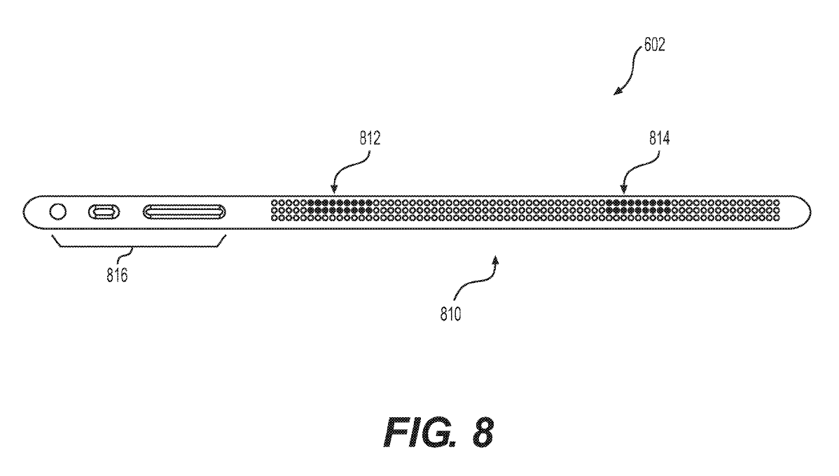

With reference to FIG. 8, which depicts a side view of the tablet device 602, the tablet device 602 further includes an audio module 810. In the depicted embodiment, the audio module 810 comprises two sets of speakers—a first speaker 812 and a second speaker 814.

The tablet device 602 can include a set of additional ports, generally depicted at 816. The set of additional ports 816 can have one or more of:
Audio out port (such as 3.5mm audio out port)
Micro USB port
Mini-HDMI video output
Micro SD card slot
Etc.

It should be noted that the exact number, placement or mix of the ports within the set of additional ports 816 is not limited to those depicted in FIG. 8.

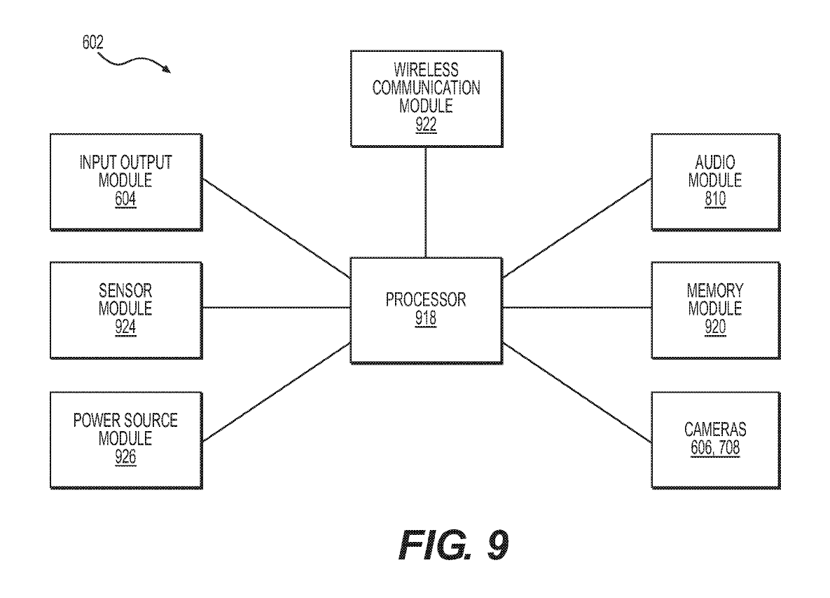

With reference to FIG. 9, there is depicted a schematic diagram of the tablet device 602, which will be used to describe additional details of the general construction and structure of the tablet device 602.

The tablet device 602 may comprise a processor 918. In a particular embodiment, the processor 918 may comprise one or more processors and/or one or more microcontrollers configured to execute instructions and to carry out operations associated with the operation of the tablet device 602. In various embodiments, processor 918 may be implemented as a single-chip, multiple chips and/or other electrical components including one or more integrated circuits and printed circuit boards. Processor 918 may optionally contain a cache memory unit (not depicted) for temporary local storage of instructions, data, or computer addresses. By way of example, the processor 918 may include one or more processors or one or more controllers dedicated for certain processing tasks of the tablet device 602 or a single multi-functional processor or controller.

The processor 918 is operatively coupled to the aforementioned input output module 604, the audio module 810 and the cameras 606, 708.

The processor 918 is further coupled to a memory module 920. The memory module 920 may encompass one or more storage media and generally provide a place to store computer code (e.g., software and/or firmware). By way of example, the memory module 920 may include various tangible computer-readable storage media including Read-Only Memory (ROM) and/or Random-Access Memory (RAM). As is well known in the art, ROM acts to transfer data and instructions uni-directionally to the processor 918, and RAM is used typically to transfer data and instructions in a bi-directional manner.

Memory module 920 may also include one or more fixed storage devices in the form of, by way of example, hard disk drives (HDDs), solid-state drives (SSDs), flash-memory cards (e.g., Secured Digital or SD cards, embedded MultiMediaCard or eMMD cards), among other suitable forms of memory coupled bi-directionally to the processor 918. Information may also reside on one or more removable storage media loaded into or installed in the tablet device 602 when needed. By way of example, any of a number of suitable memory cards (e.g., SD cards) may be loaded into the tablet device 602 on a temporary or permanent basis (using one or more of the set of additional ports 816, as an example).

The memory module 920 may store inter alia a series of computer-readable instructions, which instructions when executed cause the processor 918 (as well as other components of the tablet device 602) to execute the various operations described herein.

In various particular embodiments, the tablet device 602 may additionally comprise a wireless communication module 922 and a sensor module 924, both operably connected to the processor 918 to facilitate various functions of tablet device 602.

Wireless communication module 922 can be designed to operate over one or more wireless networks, for example, a wireless PAN (WPAN) (such as, for example, a BLUETOOTH WPAN, an infrared PAN), a WI-FI network (such as, for example, an 802.11a/b/g/n WI-FI network, an 802.11s mesh network), a WI-MAX network, a cellular telephone network (such as, for example, a Global System for Mobile Communications (GSM) network, an Enhanced Data Rates for GSM Evolution (EDGE) network, a Universal Mobile Telecommunications System (UMTS) network, and/or a Long Term Evolution (LTE) network). Additionally, wireless communication module 922 may include hosting protocols such that the tablet device 602 may be configured as a base station for other wireless devices.

The sensor module 924 may include one or more sensor devices to provide additional input and facilitate multiple functionalities of the tablet device 602. Some examples of implementations of the sensor module 924 can include one or more: an accelerometer, an ambient temperature measurement device, a device for measuring the force of gravity, a gyroscope, a device for measuring ambient light, a device for measuring acceleration force, a device for measuring ambient geomagnetic field, a device for measuring a degree of rotation, a device for measuring ambient air pressure, a device for measuring relative ambient humidity, a device for measuring device orientation, a device for measuring temperature of the device, etc. It is noted that some of these devices can be implemented in hardware, software or a combination of the two.

There is also provided a power source module 926 for providing power to one or more components of the tablet device 602. In some embodiments, the power source module 926 can be implemented as rechargeable lithium-ion battery. However, other types of rechargeable (or non-rechargeable) batteries can be used. Naturally, in other embodiments in addition or as an alternative to using batteries, the power source module 926 can be implemented as main power supplier connector configured to couple the tablet device 602 to the main power source, such as standard AC power cable and plug.

In various embodiments of the present technology, various components of tablet device 602 may be operably connected together by one or more buses (including hardware and/or software), the buses not being separately numbered. As an example and not by way of limitation, the one or more buses may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, a Universal Asynchronous Receiver/Transmitter (UART) interface, a Inter-Integrated Circuit (I²C) bus, a Serial Peripheral Interface (SPI) bus, a Secure Digital (SD) memory interface, a MultiMediaCard (MMC) memory interface, a Memory Stick (MS) memory interface, a Secure Digital Input Output (SDIO) interface, a Multi-channel Buffered Serial Port (McBSP) bus, a Universal Serial Bus (USB) bus, a General Purpose Memory Controller (GPMC) bus, a SDRAM Controller (SDRC) bus, a General Purpose Input/Output (GPIO) bus, a Separate Video (S-Video) bus, a Display Serial Interface (DSI) bus, an Advanced Microcontroller Bus Architecture (AMBA) bus, or another suitable bus or a combination of two or more of these.

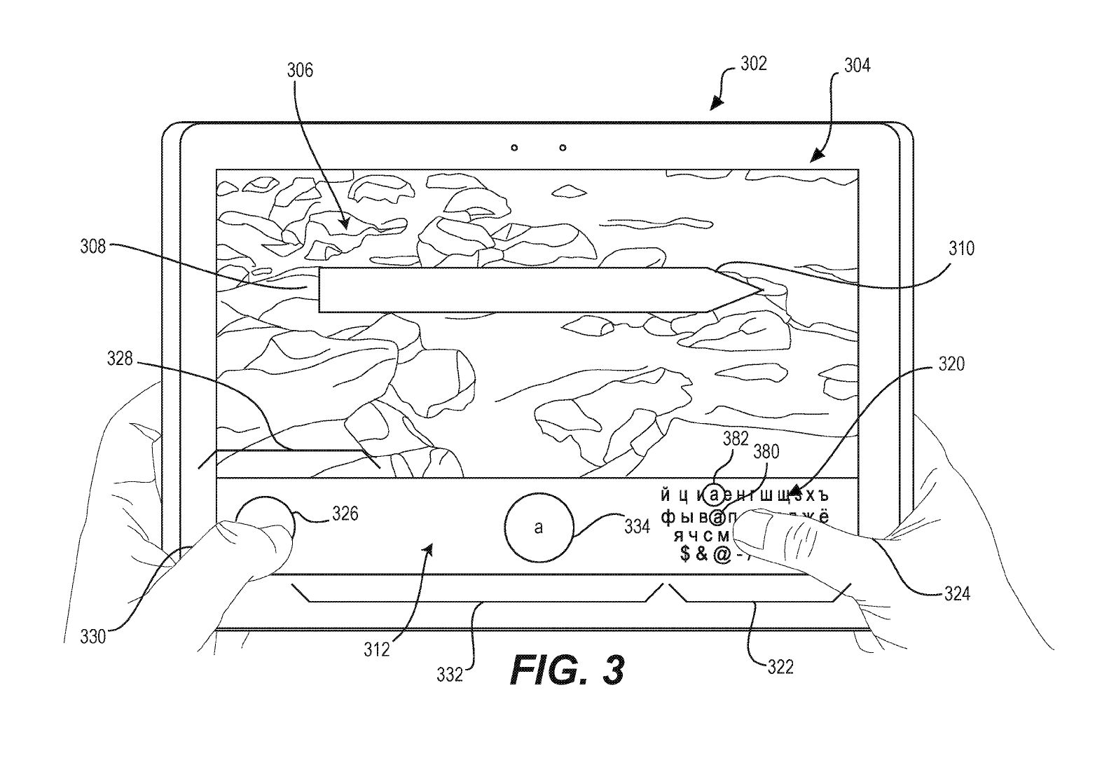

Reference is now made to FIG. 3, which depicts a front view of a tablet device 302, the tablet device 302 implemented in accordance with non-limiting embodiments of the present technology. The illustrated tablet device 302 is a SAMSUNG™ tablet device provided by Samsung Electronics Company of Suwon, South Korea. It should be, however, noted that teachings presented herein can be equally applied to other types of tablet devices 302. By the same token, the teachings presented herein can be applied to other types of electronic devices, such as but bot limited to, smartphones, Personal Digital Assistants and the like. The tablet device 302 can be implemented substantially similar to the tablet device 602 described above.

Within the illustration of FIG. 3, the tablet device 302 is shown with a touch sensitive display 304. However, in additional embodiments of the present technology, the tablet device 302 can be implemented as having the touch sensitive display 304, as well as an additional physical keys based interface (not depicted). The touch sensitive display 304 (as well as the additional physical keys based interface potentially present within the tablet device 302) can be said to constitute a “machine-user interface” of the tablet device 302.

The touch sensitive display 304 displays a home screen 306. The exact implementation of the home screen 306 is not limited, however, in the implementation depicted in FIG. 3, the home screen 306 comprises a general viewing area 308, a command interface 310 and a symbol entry area 312 (the symbol entry area 312 implementing the virtual key board implemented in accordance with embodiments of the present technology).

In some embodiments of the present technology, the general viewing area 308 display a background image, however, in alternative embodiments the background image can be omitted. In yet additional embodiments, the background image can be selected and updated from time to time by a user (not depicted). It is noted that the image displayed in the general viewing area 308 can be static, dynamic or animated.

The command interface 310 can be implemented as a multi-functional interface, otherwise known as an omnibox 310. Generally speaking, the omnibox 310 can enable the user to enter (i) a search query for searching one or more of locally stored information or remotely stored information (i.e. performing a web search or the like) and (ii) a command for controlling operation of the tablet device 302.

In accordance with embodiments of the present technology, the symbol entry area 312 is configured to allow the user operating the tablet device 302 to enter one or more symbols into the omnibox 310. However, it should be expressly understood that the symbol entry area 312 can be used to enable the user to enter symbols in interfaces other than the omnibox 310, which other interfaces include application interfaces, various widgets, as well as any available interfaces within the tablet device 302.

In accordance with embodiments of the present technology, the symbol entry area 312 comprises a symbol selection tool 320, the symbol selection tool 320 being presented within a first portion 322 of the symbol entry area 312. The symbol selection tool 320 displays a plurality of symbols from which a selection can be made by the user (not depicted) operating the tablet device 302. In other words, the symbol selection tool 320 can present to the user a virtual keyboard for selecting one or more symbols therefrom.

Within the depicted embodiment, the symbol selection tool 320 displays a Russian (Cyrillic) alphabet selection tool. However, it is expected that those of ordinary skill in the art can adapt the symbol entry area 312 to other alphabets (such as Latin, Arabic or Hebrew alphabets) or other symbols (such as logograms used in Chinese or Japanese scripts) and the like. Additionally, even though the symbol entry area 312 is depicted as enabling the user to select symbols of an alphabet, this does not need to be so in every embodiment of present technology, and as such, the symbol entry area 312 can be used for entering special symbols, a set of characters that are not alphabets and the like.

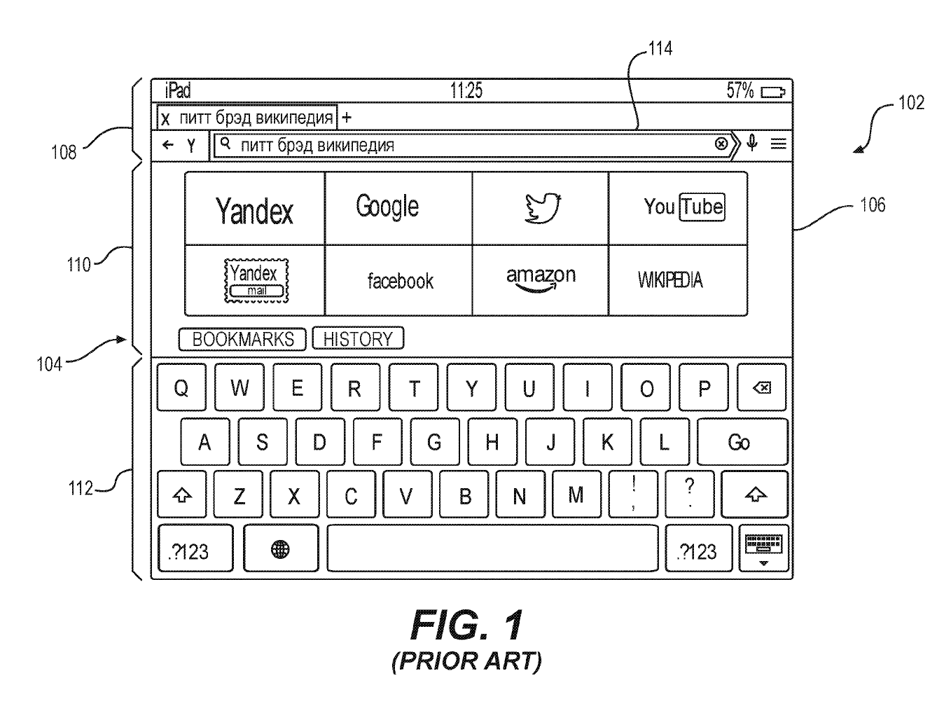

By comparison of the symbol entry area 312 of the embodiments of the present technology with the virtual key board 112 of the prior art as depicted in FIG. 1, one can see that the size of the symbols presented within the symbol entry area 312 are comparatively smaller that the size of the symbols presented within the virtual key board 112. The exact size of the symbols presented within the virtual key board 112 can be selected by the manufacturer of the tablet device 302 and/or adjusted by the user of the tablet device 302.

According to embodiments of the present technology the symbol entry area 312 is specifically adapted to enable the user to slide a first finger 324 over the area of the symbol entry area 312. As the user slides the first finger 324 over the symbol entry area 312, the symbol entry area 312 generates and the processor 918 acquires a first command, the first command representative of a symbol associated with the position of the first finger 324 of the user. As the user continues to move the first finger 324 over the symbol entry area 312, symbol entry area 312 generates and the processor 918 acquires a second command, the second command representative of a symbol associated with the then position of the first finger 324 of the user.

With specific reference to FIG. 3, the first finger 324 of the user is positioned over a symbol representative of a letter “a”, hence, the letter “a” is highlighted within the symbol entry area 312, the highlighted letter “a” being depicted at 380. Within the depicted embodiment, the highlighting is executed by means of a placing a circular symbol of a different color to highlight the currently “active” symbol, however any other possible means for highlighting the currently active symbol can be used (such as but not limited to: a different color, a different size, animation or a combination of these and/or other means). In addition, there is displayed a symbol representation 382, showing the elected symbol “a” in a more pronounced manner. In is noted that the symbol representation 382 can be omitted in other embodiments of the present technology.

Within this configuration, the symbol entry area 312 generates and the processor 918 acquires a first command, the first command representative of the symbol “a”, the symbol “a” being the one currently being selected by the user using the symbol entry area 312.

If the user were to move her first finger 324 to the left of the symbol “a”, a symbol “B” would be highlighted as an active one and the symbol “a” would cease being highlighted as the active one. By the same token, if the user were to move her first finger 324 to the right of the symbol “a”, a symbol “n” would be highlighted as an active one and the symbol “a” would cease being highlighted as the active one. Just as another example, if the user were to move her first finger 324 down from the symbol “a”, a symbol “c” would be highlighted as an active one and the symbol “a” would cease being highlighted as the active one.

In accordance with embodiments of the present technology, the symbol entry area 312 comprises an entry confirmation tool 326, the entry confirmation tool 326 being presented within a second portion 328 of the symbol entry area 312. Within the depicted embodiment, the entry confirmation tool 326 is implemented as a round button. However, in alternative embodiments, the entry confirmation tool 326 can be presented as a differently-shaped button with or without text, with or without animation, etc. In yet additional embodiments of the present technology the entry confirmation tool 326 does not need to be implemented in a specific graphical representation. Rather, the entry confirmation tool 326 can be implicitly defined within the second portion 328. For example, it can be implicitly defined that the area in the left extreme portion of the symbol entry area 312 (such as the area generally corresponding to the size of the entry confirmation tool 326 depicted in FIG. 3, but can also be smaller or larger) can be dedicated to the function to be described with reference to the entry confirmation tool 326.

Within the illustrated embodiment of FIG. 3 and within the alternative examples provided in the preceding paragraph, the entry confirmation tool 326 has been implemented as a button (or broadly speaking as an area) defined within the touch sensitive display 304 or in, other words, as a virtual keyboard (which is different from the virtual keyboard presented by the symbol selection tool 320). However, in yet further alternative embodiments of the present technology, the entry confirmation tool 326 can be implemented as one or more physical buttons. For example, the entry confirmation tool 326 can be implemented as a dedicated button specifically designed to implement the entry confirmation tool 326 function. Alternatively, the entry confirmation tool 326 can be implemented as a function assigned to a physical button that otherwise performs a different function. For example, in those cases where the tablet device 302 is implemented as an iPad, the entry confirmation tool 326 can be implemented as the home button, which function is assigned to the home button in the symbol entry mode (i.e. when the user indicated her desire to enter symbols and when the symbol entry area 312 is displayed).

When the user actuates the entry confirmation tool 326 (such as by means of tapping, clicking or the like using a second finger 330), the entry confirmation tool 326 generates and the processor 918 acquires a first entry confirmation command.

The processor 918 can be further configured to process the particular symbol (as selected by the user using the first finger 324 using the symbol entry area 312 (in the illustrated embodiment, the selected symbol is letter “a”) as an entry symbol (to be entered into the command interface 310, for example), only in response to the first command (i.e. the one generated in response to the user selecting a symbol using the symbol entry area 312) and the second command (i.e. the one generated by the user actuating the entry confirmation tool 326) being indicative that the user interacting with the entry confirmation tool 326 overlaps, at least partially, with the user selecting the particular symbol using the symbol entry area 312.

A special technical effect associated with the above described embodiment is that the implementation of a “split symbol selection” (i.e. when the symbol is entered only in response to the user actuating the symbol entry confirmation tool 320 while at least partially simultaneously selecting a particular symbol using the symbol entry area 312) allows to prevent false entries.

In alternative non-limiting embodiments, the processor 918 can process the particular symbol for entry if the user actuates the symbol entry confirmation tool 320 within a pre-determined time period after the user has finished selecting the particular symbol. This is particularly useful where the user has selected the particular symbol and then completely disengaged the symbol selection tool 320 (by lifting the first finger 324 off the symbol selection tool 320). Within these embodiments, when the user actuates the symbol entry confirmation tool 320, the processor 918 can process the last selected particular symbol that the user was selecting using the symbol selection tool 320 before lifting the first finger 324 off the symbol selection tool 320.

What the above means, practically speaking, the user can select the symbol she is desirous of entering by sliding the first finger 324 over the symbol entry area 312. As the user slides the first finger 324 from one symbol to another from the symbol entry area 312, the symbol entry area 312 generates and the processor 918 acquires a respective command representative of the symbol then selected. However, the processor 918 does not process the then selected symbol until the user uses the second finger 330 to actuate the entry confirmation tool 326. When the user positions the first finger 324 over the symbol the user is desirous of entering (which in this case is the letter “a”), the user uses the second finger 330 to actuate the entry confirmation tool 326. When the user uses the second finger 330 to actuate the entry confirmation tool 326, the processor 918 generates the first entry confirmation command. The processor 918 then analyses the respective command generated by the symbol entry area 312 which represents the symbol that was selected at the time when the user actuated the entry confirmation tool 326 and processes the so selected symbol for entry.

As has been mentioned above, the entry can be into the omnibox 310. Additionally or alternatively, the so processed symbol can be displayed within an additional information component 334 (to be described below). Additionally or alternatively, the processed symbol can be entered in an application (such as, for example but not limited to: a word processing application, a spreadsheet application, a map application, a game and the like).

As can be appreciated from FIG. 3, the first portion 322 and the second portion 328 of the symbol entry area 312 are located separate from each other. More specifically, the first portion 322 and the second portion 328 are separated by an information presentation space 332, the information presentation space 332 is configured for displaying the additional information component 334. In the depicted embodiment, the additional information component 334 displays the symbol being entered, which in this case comprises the letter “a”. However, other implementations for the additional information component 334 are possible and will be described in greater detail herein below.

It is noted that the first portion 322 and the second portion 328, in the depicted embodiment, are located at opposing ends of the touch sensitive display 304. This is particularly convenient to enable the user use the symbol entry area 312 using two hands—the first hand (associated with the first finger 324) and the second hand (associated with the second finger 330).

It is noted that in the depicted embodiment, the entry confirmation tool 326 is located on the left, while the symbol selection tool 320 is located on the right. In alternative embodiments of the present technology, the position of the entry confirmation tool 326 and the symbol selection tool 320 can be reversed. In some embodiments, the spatial positioning of the entry confirmation tool 326 and the symbol selection tool 320 can be a user-selectable feature. This can be particularly useful (but not limited) to left-handed users, who may prefer the reversed spatial positioning of the entry confirmation tool 326 and the symbol selection tool 320 to the one depicted in FIG. 3.

In some embodiments of the present technology, the entry confirmation tool 326 can be used for allowing the user to enter special symbols and/or additional symbol commands. This is particularly useful but is not necessarily limited to those embodiments where the entry confirmation tool 326 is implemented as part of the touch sensitive display 304. For example, if the user uses the second finger 330 and “swipes up” over the entry confirmation tool 326, the entry confirmation tool 326 can generate and the processor 918 can acquire a signal that the next symbol to be processed (when the user selects a particular symbol using the symbol selection tool 320 and actuates the entry confirmation tool 326 to indicate acceptance of the selected symbol), is to be processed as a capital letter. This is an example of a command to be executed in conjunction with the next symbol to be processed.

Additionally, the user can use the entry confirmation tool 326 to enter special characters. For example, when the user uses the second finger 330 and “swipes right” over the entry confirmation tool 326, the entry confirmation tool 326 generates and the processor 918 acquires a signal representative of an entry of a special character, such as a space character. As another example, when the user uses the second finger 330 and “swipes down” over the entry confirmation tool 326, the entry confirmation tool 326 generates and the processor 918 acquires a signal representative of an entry of a special character, such as a comma.

Naturally, the special characters assigned to the various swipes (or other actions with the entry confirmation tool 326) can vary. Also, in some embodiments, the special characters assigned to the various swipes (or other actions with the entry confirmation tool 326) can be pre-defined by the manufacturer and/or the distributor of the tablet device 302. In alternative embodiments, the special characters assigned to the various swipes (or other actions with the entry confirmation tool 326) can be selected (and amended) by the user.

Additionally, the user can use the entry confirmation tool 326 to execute a command associated with the already processed symbol. For example, when the user uses the second finger 330 and “swipes left” over the entry confirmation tool 326, the entry confirmation tool 326 generates and the processor 918 acquires a signal representative of a command to delete the last entered symbol.

In yet other examples, the user can use the entry confirmation tool 326 to change a characteristic of the symbol selection tool 320. The characteristic is not particularly limited and can include (but is not limited to): switching the language of the symbols displayed within the entry confirmation tool 326, switching the symbols displayed within the entry confirmation tool 326 from letters to numerals, from numerals to special symbols and vice versa.

As an example of the above, when the user uses the second finger 330 and executes a “long tap” over the entry confirmation tool 326, the entry confirmation tool 326 generates and the processor 918 acquires a signal representative of a command to switch the symbols displayed within the entry confirmation tool 326 to special symbols. As another example of the above, when the user uses the second finger 330 and executes a “double tap” over the entry confirmation tool 326, the entry confirmation tool 326 generates and the processor 918 acquires a signal representative of a command to switch the symbols displayed within the entry confirmation tool 326 to a different language.

It should be expressly understood that the various actions performed by the user over the entry confirmation tool 326 are provided as examples only. The exact combinations of the actions performed by the user over the entry confirmation tool 326 and the associated commands generated/executed can vary in the various embodiments of the present technology.

It should be recalled that the information presentation space 332 can be used for displaying the additional information component 334. In the examples provided above, the additional information component 334 can be implemented as a display of the symbol being entered. However, in alternative non-limiting embodiments the information presentation space 332 can be used for displaying other types of the additional information component 334.

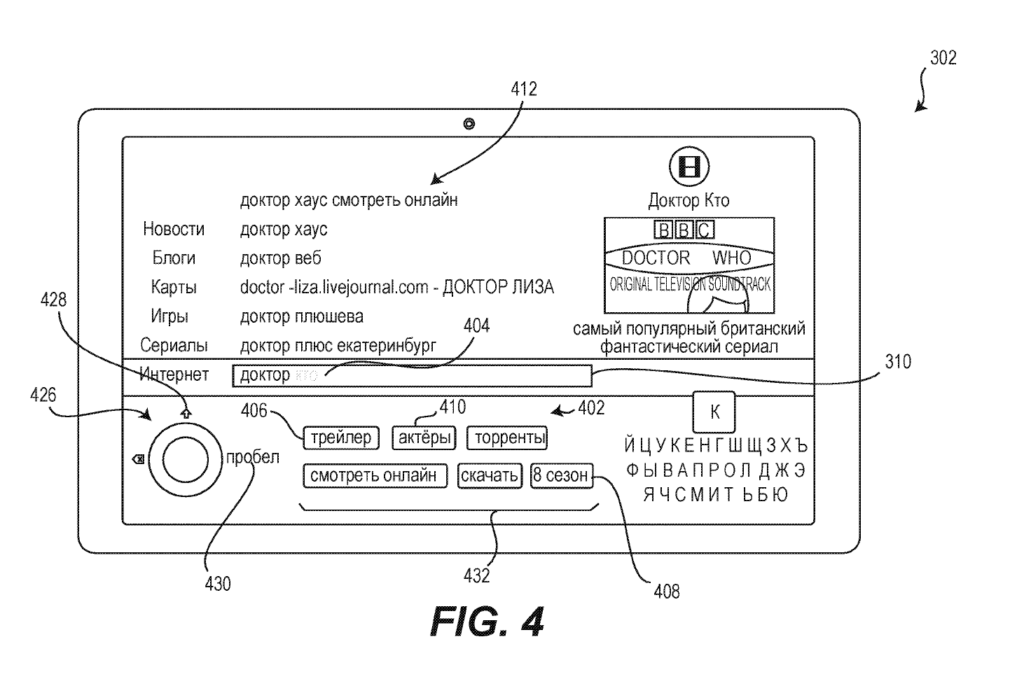

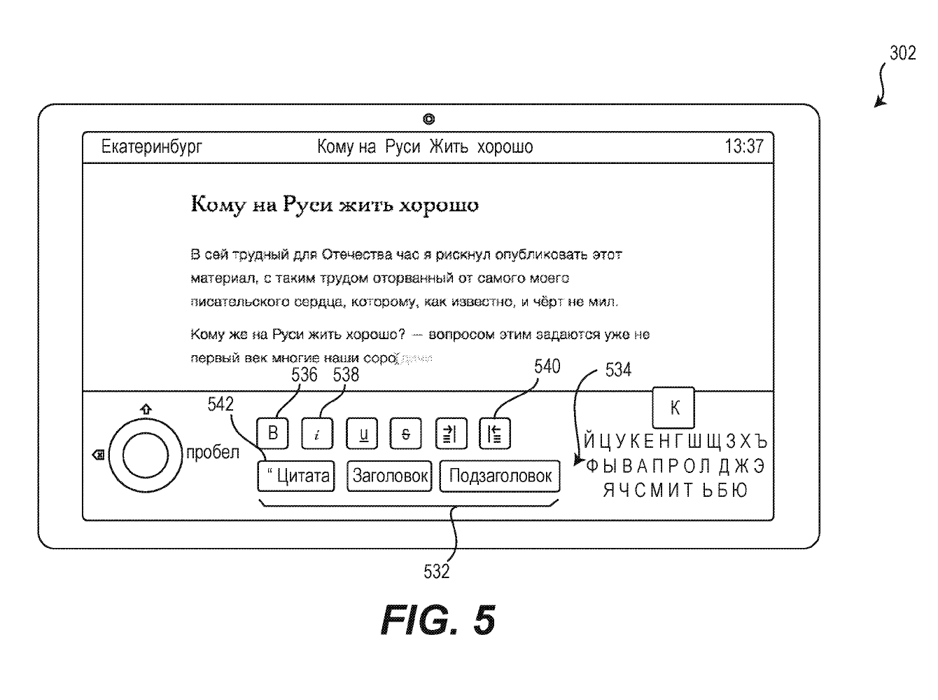

For example, with reference to FIG. 4 and FIG. 5, there is depicted other alternative embodiments for implementing the information presentation space 332, depicted in FIG. 4 as an information presentation space 432. Within the depicted embodiment of FIG. 4, the information presentation space 432 displays a plurality of query completion suggests 402, the plurality of query completion suggests 402 including suggests for completing a search query 404 entered into the omnibox 310. In the depicted example, where the user has entered a partial search query “doctor” (in Russian: “ [symbol] OKTOP”) and the processor 918 generated an in-omnibox suggest “who” (in Russian: “ [symbol] ”), depicted in FIG. 4, respectively, in the darker color for the partial search query and a lighter color for the in-omnibox suggest.

The processor 918 has further generated the plurality of query completion suggests 402, which include inter alfa: a first suggest 406, a second suggest 408 and a third suggest 410. The first suggest 406 includes a suggest “trailer” (in Russian: “ [symbol] ”).The second suggest 408 includes a suggest “8^{th} season” (in Russian: “8 [symbol] ”). The third suggest 410 includes a suggest “actors” (in Russian: “ [symbol] ”).

It is noted that the algorithm that is used to generate the suggests within the plurality of query completion suggests 402 can be the same as the one used for generating a search engine generated list of query completion suggests 412. In other words, the list of suggests that are used for generating the plurality of query completion suggests 402 can be received from the search engine that has generated information for the search engine generated list of query completion suggests 412.

Alternatively, the processor 918 can generate the suggests within the plurality of query completion suggests 402 based on an internal algorithm, which can be based, for example, on past search behavior associated with the user of the tablet device 302.

It is noted that in the embodiment depicted in FIG. 4, an entry confirmation tool 426 is implemented differently from the entry confirmation tool 326 of FIG. 3. More specifically, the entry confirmation tool 426 has an indication 428 and an indication 430 of respective additional functions that can be executed using the entry confirmation tool 426. More specifically, the indication 428 depicts an up-facing arrow, indicative of if the user uses the second finger 330 and “swipes up” over the entry confirmation tool 426, the entry confirmation tool 426 will generate a signal that the next symbol to be processed needs to be processed as a capital letter. The indication 430 depicts a word “space” (in Russian: “ [symbol] ”), which is indicative that if the user uses the second finger 330 and “swipes right” over the entry confirmation tool 426, the entry confirmation tool 426 will generate a signal representative of an entry of the special denoting a space character.

FIG. 5 depicts yet another alternative embodiments for implementing the information presentation space 332, depicted in FIG. 5 as an information presentation space 532. It is noted that the tablet device 302 depicted in FIG. 5 is in an application execution mode, which application is a word processor. As such, the information presentation space 532 can be used for presenting to the user a list of special commands 534 associated with the word processor application. Within the depicted embodiment, the list of special commands 534 can include inter alfa: a first command 536 (to make the text bold), a second command (to make the text italic), a third command 540 (to decrease indent) and a fourth command 542 (to enter a citation, which is depicted in Russian as “ [symbol] ”).

The processor 918 has access (such as from the memory module 920) to machine-readable instructions, which machine readable instructions when executed by the processor 918 cause the processor to execute routines and method described below. More specifically, the processor 918 can execute a method 1000 for processing a user input command.

1002—the processor 918 is configured to present on a first portion of the machine-user interface a symbol selection tool, the first portion being a portion of a touch-sensitive screen

The method 1000 starts at step 1002, where the processor 918 presents on a first portion 322 of the machine-user interface a symbol selection tool 320, the first portion 322 being a portion of a touch-sensitive screen 304.

Step 1004—presenting on a second portion of the machine-user interface an entry confirmation tool

Next, at step 1004, the processor 918 presents on a second portion 328 of the machine-user interface an entry confirmation tool 326.

In some embodiments of the method 1000, the first portion 322 of the machine-user interface comprises a first virtual keyboard. In some embodiments of the method 1000, the second portion 328 comprises a second virtual keyboard. In some embodiments of the method 1000, the first portion 322 of the machine-user interface comprises a first virtual keyboard and the second portion 328 comprises a second virtual keyboard, and the first virtual key board located in a first part of the machine-user interface and the second virtual keyboard is located in a second part of the machine-user interface. In some embodiments of the method 1000, the first part and the second part are located at opposing ends of the machine-user interface to enable the user to operate the first virtual keyboard with one hand and the other virtual keyboard with another hand.

Step 1006—receiving, from the symbol selection tool, a first command representative of the user selecting a particular symbol using the symbol selection tool

Next, at step 1006, the processor 918 receives, from the symbol selection tool 320, a first command representative of the user selecting a particular symbol using the symbol selection tool 320.

In some implementations of the method 1000, the receiving, from the symbol selection tool 320, a first command representative of the user selecting a particular symbol using the symbol selection tool 320 is executed in response to: the user executing a sliding action over the symbol selection tool 320, the symbol selection tool 320 having a plurality of discrete zones, each of the plurality of discrete zones corresponding to an associated symbol; the first command being generated in response to the user sliding from one of the plurality of discrete zones to another one of the plurality of discrete zones.

Step 1008—receiving, from the entry confirmation tool, a second command representative of the user interacting with the entry confirmation tool

Next, at step 1008, the processor 918 receives, from the entry confirmation tool 326, a second command representative of the user interacting with the entry confirmation tool 326. In some implementations of the method 1000, the receiving, from the entry confirmation tool 326, a second command representative of the user interacting with the entry confirmation tool 326 is executed in response to the user actuating the entry confirmation tool 326.

Step 1010—processing the particular symbol as an entry symbol, only in response to the first command and the second command being indicative that the user interacting with the entry confirmation tool overlaps, at least partially, with the user selecting the particular symbol

Next, at step 1010, the processor 918 processes the particular symbol as an entry symbol, only in response to the first command and the second command being indicative that the user interacting with the entry confirmation tool 326 overlaps, at least partially, with the user selecting the particular symbol.

The method 1000 can then terminate.

In some implementations of the method 1000, the receiving, from the symbol selection tool 320, a first command representative of the user selecting a particular symbol using the symbol selection tool 320 is executed in response to: the user executing a sliding action over the symbol selection tool 320, the symbol selection tool 320 having a plurality of discrete zones, each of the plurality of discrete zones corresponding to an associated symbol; the first command being generated in response to the user sliding from one of the plurality of discrete zones to another one of the plurality of discrete zones.

In some implementations of the method 1000, after sliding to the another one of the plurality of discrete zones, the user disengages the symbol selection tool and wherein the processing the particular symbol as an entry symbol is executed in response to the first command and the second command being indicative that the user interacting with the entry confirmation tool is executed within the predetermined time period after the user disengaging the symbol selection tool.

In some implementations of the method 1000, after sliding to the another one of the plurality of discrete zones, the user disengages the symbol selection tool 320 and the processing the particular symbol as an entry symbol is executed in response to the first command and the second command being indicative that the user interacting with the entry confirmation tool 326 is executed within the predetermined time period after the user disengaging the symbol selection tool 320.

In some embodiments of the method 1000, the first part and the second part can be separated by an information presentation space 332. As such, the method 1000 can additionally comprise presenting, within the information presentation space 332, an additional information component 334. In some embodiments of the method 1000, the additional information component 334 comprises a representation of the symbol being processed. In some embodiments of the method 1000, the additional information component 334 comprises a suggested entry completion, based at least in part on the symbol being processed. In some embodiments of the method 1000, the method 1000 further comprises predicting a plurality of potential suggested entry completions and selecting a subset of the potential suggested entry completions, the subset of the potential suggested entry completions including at least the suggested entry completion.

In some embodiments of the method 1000, the method 1000 further comprises displaying, within another portion of the machine-user interface an application having content, and the additional information component 334 comprises a command interface for enabling the user to enter at least one command for interacting with at least one of the application and the content.

In some embodiments of the method 1000, the method 1000 further comprises presenting, within the entry confirmation tool 326, a special symbol command interface, the special symbol command interface for enabling the user to enter at least one command for augmenting the symbol being entered.

In some embodiments of the method 1000, the method 1000 further comprises:

receiving, from the entry confirmation tool 326, a third command, the third command being of a different type from the second command; and processing the third command as an indication of an entry of a special symbol, different from the particular symbol potentially selectable using the symbol selection tool 320.

In some implementations of the method 1000, the second portion 328 comprises a physical keyboard. In some implementations of the method 1000, the second portion 328 of the machine-user interface is implemented as a virtual key board, and receiving the second command is executed in response to a tap of at least a portion of the entry confirmation tool 326; receiving the third command is executed in response to a swipe over at least a portion of the entry confirmation tool.

In some implementations of the method 1000, the method 1000 further comprises detecting a direction of the swipe and wherein the special symbol is selected based on the direction of the swipe.

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

One skilled in the art will appreciate when the instant description refers to “receiving data” from a user that the electronic device executing receiving of the data from the user may receive an electronic (or other) signal from the user. One skilled in the art will further appreciate that displaying data to the user via a user-graphical interface (such as the screen of the electronic device and the like) may involve transmitting a signal to the user-graphical interface, the signal containing data, which data can be manipulated and at least a portion of the data can be displayed to the user using the user-graphical interface.

Some of these steps and signal sending-receiving are well known in the art and, as such, have been omitted in certain portions of this description for the sake of simplicity. The signals can be sent-received using optical means (such as a fibre-optic connection), electronic means (such as using wired or wireless connection), and mechanical means (such as pressure-based, temperature based or any other suitable physical parameter based).

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1-22. (canceled)

23. A method of processing a user input command, the method executable on an electronic device, the electronic device having a machine-user interface, the method comprising:
presenting on a first portion of the machine-user interface a symbol selection tool, the first portion being a portion of a touch-sensitive screen;
presenting on a second portion of the machine-user interface an entry confirmation tool;
receiving, from the symbol selection tool, a first command representative of the user selecting a particular symbol using the symbol selection tool;
receiving, from the entry confirmation tool, a second command representative of the user interacting with the entry confirmation tool; and
processing the particular symbol as an entry symbol, only in response to the first command and the second command being indicative that the user interacting with the entry confirmation tool overlaps, at least partially, with the user selecting the particular symbol using the symbol selection tool.

24-43. (canceled)

44. An electronic device comprising:
a user input output interface;
a processor coupled to the user input output interface, the processor configured to
present on a first portion of the machine-user interface a symbol selection tool, the first portion being a portion of a touch-sensitive screen;
present on a second portion of the machine-user interface an entry confirmation tool;
receive, from the symbol selection tool, a first command representative of the user selecting a particular symbol using the symbol selection tool;
receive, from the entry confirmation tool, a second command representative of the user interacting with the entry confirmation tool; and
process the particular symbol as an entry symbol, only in response to the first command and the second command being indicative that the user interacting with the entry confirmation tool overlaps, at least partially, with the user selecting the particular symbol using the symbol selection tool.

45. The electronic device of claim 44, wherein the first portion of the machine-user interface comprises a first virtual keyboard.

46. The electronic device of claim 44, wherein the second portion comprises a second virtual keyboard.

47. The electronic device of claim 44, wherein the first portion of the machine-user interface comprises a first virtual keyboard and the second portion comprises a second virtual keyboard, and wherein the first virtual key board located in a first part of the machine-user interface and the second virtual keyboard is located in a second part of the machine-user interface.

48. The electronic device of claim 47, wherein the first part and the second part are located at opposing ends of the machine-user interface to enable the user to operate the first virtual keyboard with one hand and the other virtual keyboard with another hand.

49. The electronic device of claim 47, wherein the first part and the second part are separated by an information presentation space.

50. The electronic device of claim 49, the processor being further configured to present, within the information presentation space, an additional information component.

51. The electronic device of claim 50, wherein the additional information component comprises a representation of the symbol being processed.

52. The electronic device of claim 50, wherein the additional information component comprises a suggested entry completion, based at least in part on the symbol being processed.

53. The electronic device of claim 50, the processor being further configured to display, within another portion of the machine-user interface an application having content, and wherein the additional information component comprises a command interface for enabling the user to enter at least one command for interacting with at least one of the application and the content.

54. The electronic device of claim 44, the processor being further configured to present, within the entry confirmation tool, a special symbol command interface, the special symbol command interface for enabling the user to enter at least one command for augmenting the symbol being entered.

55. The electronic device of claim 44, the processor being further configured to:
receive, from the entry confirmation tool, a third command, the third command being of a different type from the second command; and
process the third command as an indication of an entry of a special symbol, different from the particular symbol potentially selectable using the symbol selection tool.

56. The electronic device of claim 44, wherein the processor is configured to receive, from the symbol selection tool, a first command representative of the user selecting a particular symbol using the symbol selection tool, in response to:
the user executing a sliding action over the symbol selection tool, the symbol selection tool having a plurality of discrete zones, each of the plurality of discrete zones corresponding to an associated symbol;
the first command being generated in response to the user sliding from one of the plurality of discrete zones to another one of the plurality of discrete zones.

57. The electronic device of claim 56, wherein after sliding to the another one of the plurality of discrete zones, the user disengages the symbol selection tool and wherein the processing the particular symbol as an entry symbol is executed in response to the first command and the second command being indicative that the user interacting with the entry confirmation tool is executed within the predetermined time period after the user disengaging the symbol selection tool.

58. The electronic device of claim 44, wherein the electronic device comprises a tablet device.

59. The electronic device of claim 58, wherein the tablet device is optimized for use in a landscape mode of operation.

60. The method of claim 23, further comprising not processing the particular symbol as the entry symbol in response to one of: (i) an absence of the second command, and (ii) in response to the first command and the second command being indicative that the user interacting with the entry confirmation tool does not overlap, at least partially, with the user selecting the particular symbol using the symbol selection tool.

61. The electronic device of claim 44, the processor further configured to not process the particular symbol as the entry symbol in response to one of: (i) an absence of the second command, and (ii) in response to the first command and the second command being indicative that the user interacting with the entry confirmation tool does not overlap, at least partially, with the user selecting the particular symbol using the symbol selection tool.
